(19) United States
(12) Patent Application Publication
(10) Pub. No.: US 2016/0047670 A1
(43) Pub. Date: Feb. 18, 2016

(54) METHOD AND APPARATUS FOR NAVIGATION

(71) Applicant: HERE GLOBAL B.V., LB Veldhoven (NL)

(72) Inventors: Raimund GRÜN, Eschborn (DE); Martin PFEIFLE, Seewald (DE); Boris GUMHOLD, Frankfurt (DE)

(21) Appl. No.: 14/778,928

(22) PCT Filed: May 27, 2013
(86) PCT No.: PCT/EP2013/060862

§ 371 Date: Sep. 21, 2015

(51) Int. Cl. G01C 21/36; G06F 17/27; G06F 17/28; G06F 17/22; G06F 3/0482; G06F 17/30

(52) U.S. Cl. CPC G01C 21/3611; G06F 3/0482; G06F 17/30684; G06F 17/2863; G06F 17/2223; G06F 17/276

(57) ABSTRACT

A method for generating a next valid character tree may comprise:—providing a first name, the first name comprising a first character represented by a first character code,—providing a second name, the second name comprising a second character represented by a second character code, wherein the first character and the second character are homoglyphs with respect to each other, and—generating a next valid character tree according to the names such that the next valid character tree comprises a combined node, which is a place holder for the first character and for the second character.

### FIELD

Some versions relate to generating a search tree, which indicates next valid characters for inputting a name at a user interface. Some versions relate to inputting a word by using the search tree.

### BACKGROUND

When using a navigation device, the user may define the name of a location by selecting the characters of the name in consecutive order. The characters may be selected e.g. by using a keyboard implemented on a touch screen.

### SUMMARY

Some versions may relate to a method for generating a search tree. Some versions may relate to an apparatus for generating a search tree. Some versions may relate to a method for making a selection. Some versions may relate to an apparatus for making a selection. Some versions may relate to a method for navigation. Some versions may relate to an apparatus for navigation. Some versions may relate to next valid character tree.

According to a first aspect, there is provided a method comprising:

providing a first name (NAME1), the first name comprising a first character (C1_{LAT}) represented by a first character code,

providing a second name (NAME2), the second name comprising a second character (C1_{CYR}) represented by a second character code, wherein the first character and the second character are homoglyphs with respect to each other, and

generating a next valid character tree (NVCT1) according to the names (NAME1, NAME2) such that the next valid character tree (NVCT1) comprises a combined node (N_{1,0,0}), which is a place holder for the first character (C1_{LAT}) and for the second character (C1_{CYR}) .

According to a second aspect, there is provided an apparatus (500) comprising one or more processors (CNT1, 1246) configured generate a next valid character tree (NVCT1) according to a first name (NAME1) and according to a second name (NAME2) such that the next valid character tree (NVCT1) comprises nodes for selecting the first name (NAME1) and nodes for selecting the second name (NAME2), wherein the first name (NAME1) comprises a first character (C1_{LAT}) represented by a first character code, the second name (NAME2) comprises a second character (C1_{CYR}) represented by a second character code, the next valid character tree (NVCT1) comprises a combined node (N_{1,0,0}), which is a place holder for a first character (C1_{LAT}) and for a second character (C1_{CYR}), and the first character (C1_{LAT}) and the second character (C1_{CYR}) are homoglyphs with respect to each other.

According to a third aspect, there is provided a computer program (PROG1) including one or more computer-executable instructions which when executed by one or more processors cause a system to carry out generating a next valid character tree (NVCT1) according to a first name (NAME1) and according to a second name (NAME2) such that the next valid character tree (NVCT1) comprises a combined node (N_{1,0,0}), which is a place holder for a first character (C1_{LAT}) and a second character (C1_{CYR}), wherein the next valid character tree (NVCT1) comprises nodes for selecting the first name (NAME1), which comprises a first character (C1_{LAT}) represented by a first character code, the next valid character tree (NVCT1) comprises nodes for selecting the second name, which comprises the second character (C1_{CYR}) represented by a second character code, and the first character and the second character are homoglyphs with respect to each other.

According to a fourth aspect, there is provided a computer program product embodied on a non-transitory computer-readable medium, said computer program including one or more computer-executable instructions which when executed by one or more processors cause a system to carry out generating a next valid character tree (NVCT1) according to a first name (NAME1) and according to a second name (NAME2) such that the next valid character tree (NVCT1) comprises a combined node (N_{1,0,0}), which is a place holder for a first character (C1_{LAT}) and a second character (C1_{CYR}), wherein the next valid character tree (NVCT1) comprises nodes for selecting the first name (NAME1), which comprises a first character (C1_{LAT}) represented by a first character code, the next valid character tree (NVCT1) comprises nodes for selecting the second name, which comprises the second character (C1_{CYR}) represented by a second character code, and the first character and the second character are homoglyphs with respect to each other.

According to a fifth aspect, there is provided a means for generating a next valid character tree (NVCT1) according to a first name (NAME1) and according to a second name (NAME2) such that the next valid character tree (NVCT1) comprises a combined node (N_{1,0,0}), which is a place holder for a first character (C1_{LAT}) and a second character (C1_{CYR}), wherein the next valid character tree (NVCT1) comprises nodes for selecting the first name (NAME1), which comprises a first character (C1_{LAT}) represented by a first character code, the next valid character tree (NVCT1) comprises nodes for selecting the second name, which comprises the second character (C1_{CYR}) represented by a second character code, and the first character and the second character are homoglyphs with respect to each other.

According to a sixth aspect, there is provided a method comprising:

determining a list (NVCLIST1) of valid characters by accessing a next valid character tree (NVCT1), and

selecting an input character from said list (NVCLIST1) of valid characters based on user input,

wherein said next valid character tree (NVCT1) comprises:

a first set of nodes for selecting a first name (NAME1), the first name comprising a first character (C1_{LAT}) represented by a first character code,

a second set of nodes for selecting a second name (NAME2), the second name comprising a second character (C1_{CYR}) represented by a second character code,

wherein the first character and the second character are homoglyphs with respect to each other, and said next valid character tree (NVCT1) comprises a combined node (N_{1,0,0}), which is a place holder for the first character (C1_{LAT}) and for the second character (C1_{CYR}).

According to a seventh aspect, there is provided an apparatus (500), comprising:

one or more processors (CNT1) configured to determine a list (NVCLIST1) of valid characters by accessing a next valid character tree (NVCT1), and

a user interface (UIF1) for inputting a character selected from said list (NVCLIST1) of valid characters,

wherein said next valid character tree (NVCT1) comprises:

a first set of nodes for selecting a first name (NAME1), the first name comprising a first character (C1_{LAT}) represented by a first character code,

a second set of nodes for selecting a second name (NAME2), the second name comprising a second character (C1_{CYR}) represented by a second character code,

wherein the first character and the second character are homoglyphs with respect to each other, and said next valid character tree (NVCT1) comprises a combined node (N_{1,0,0}), which is a place holder for the first character (C1_{LAT}) and for the second character (C1_{CYR}).

According to an eighth aspect, there is provided a data structure comprising a next valid character tree (NVCT1), which when accessed by one or more processors:

defines a set (NVCLIST1) of characters available for selection, and

enables selecting a name from a group of names according to a character selected from said set (NVCLIST1) of characters,

wherein said group of names includes a first name (NAME1) and a the second name (NAME2), and said next valid character tree (NVCT1) comprises:

a first set of nodes for selecting the first name (NAME1), the first name comprising a first character (C1_{LAT}) represented by a first character code,

a second set of nodes for selecting the second name (NAME2), the second name comprising a second character (C1_{CYR}) represented by a second character code,

wherein the first character and the second character are homoglyphs with respect to each other, and said next valid character tree (NVCT1) comprises a combined node (N_{1,0,0}), which is a place holder for the first character (C1_{LAT}) and for the second character (C1_{CYR}).

A search tree may indicate next valid characters for inputting a name at a user interface. The search tree may be called e.g. as the next valid character tree. The next valid character tree may be used for facilitating user input e.g. when using a navigation system. An example of a next valid character tree has been described e.g. in the Navigation Data Standard (NDS) of the Navigation Data Standard Association.

A location, a point of interest, or another search term may be defined by a name. The user may type or select a character for the first position of the name. A list of valid characters for the next position in the name may be determined by using a next valid character tree. Characters which are not contained in a list of valid characters may be invalid. Invalid characters may be omitted in order to make the entry of the search term faster. Invalid characters may be omitted in order to avoid erroneously selecting a name, which is not contained in a navigation database.

The navigation database may also contain location names, which are written by using different character systems. For example, the database may contain a name “Munich” written by using Latin characters, the database may contain a name “ [symbol] ” written by using Cyrillic characters, and/or the database may contain a name “Móναχo” written by using Greek characters. Each character may have unique character code e.g. for storing names in a computer-readable memory and/or for processing navigation data by a data processor.

The names contained in the database may include characters, which have identical visual appearance, but which have different character code. For example, the letters “M” appearing in the names “Munich”, “M [symbol] ”, and “Móναχo” may look the same but they may have different character codes. If the user wishes to input the location name “M [symbol] ” instead of inputting the location name “Munich”, he may need to specifically enable using Cyrillic characters instead of using Latin characters. If the user wishes to input the location name “Munich”, he may need to specifically enable using Latin characters.

According to an embodiment, a next valid character tree may comprise a combined node, which is place holder for a Latin character and for a Cyrillic character. This may reduce the time needed to input a first location name and a second location name in a situation where the first location name has Latin characters, and the second location name has Cyrillic characters. This may reduce the time needed to input a location name in a situation where the user does not even know whether the location name comprises Latin or Cyrillic characters. A next valid character tree comprising a combined node may be called e.g. an enhanced next valid character tree.

According to an embodiment, an enhanced valid character tree may be generated by converting a node of a next valid character tree from a character to a grapheme. The grapheme may be the place holder for all characters related to the homoglyphs represented by the grapheme. The siblings and child nodes of the newly created node may be created accordingly.

Two or more nodes of the next valid character tree may be combined to form a combined node associated with a grapheme. The combined node may be the place holder for all characters related to the homoglyphs represented by the grapheme. The siblings and child nodes of the newly created node may be created accordingly.

During the compilation of a navigation database, location names may be aggregated and inserted into the next valid character tree. When creating the enhanced next valid character tree, a list of homoglyphs may be used to find character groups using the same grapheme. Instead of creating one node per character, a combined node combining the homoglyph characters may be created. The combined node may be an ancestor node to one or more child nodes, respectively.

Thanks to using the enhanced next valid character tree, a user may select e.g. by using his native script. Selecting a grapheme may be easier than selecting a character in the appropriate script.

In an embodiment, size of the enhanced next valid character tree may be reduced. In particular the number of nodes of the enhanced next valid character tree may be reduced when compared with a next valid character tree where all different characters are represented by different nodes.

In an embodiment, using the enhanced next valid character tree may allow inputting a desired name by selecting one or more graphemes instead of selecting one of more characters. For example, two or three different characters may be represented by a single grapheme, and using the enhanced next valid character tree may allow inputting the desired name by using a reduced set of keys (e.g. buttons).

The user may use a first keyboard layout for inputting a first name by using a first alphabet system. In an embodiment, the user does not need to switch from the first keyboard layout to a second keyboard layout when inputting a second name with different alphabet system.

Using the enhanced next valid character tree may facilitate inputting a name, which is difficult to write and/or which is difficult to memorize.

Some location names may have an unusual or difficult spelling. Sometimes a first location name may be easily confused with a second location name. For example, the city of Mülheim (near the river Ruhr) has approximately 170000 inhabitants, whereas the town of Mühlheim (near the river Main) has approximately only 27000 inhabitants. If a user is not aware of the existence of the similar location names, the search experience may be improved e.g. by simultaneously displaying the both names. The location names may be associated with auxiliary pointers such that selecting a first name also triggers displaying the second substantially similar name.

The list of location names may also be modified by artificially generating auxiliary location names from a correct location name by making one or more common writing and/or spelling errors. The next valid character tree may be modified according to the auxiliary location names. The auxiliary name may be similar to the correct name, but not identical in writing and/or sound. Thus a misspelled name can still be found by using the next valid character tree.

A navigation database may contain a first name, which includes a first character. According to an embodiment, a second name may be converted into a second altered name before adding the second altered name into the navigation database. Altering the second name may comprise replacing a second character of the second name with the first character of the first name, when the first character and the second character are homoglyphs. Consequently, the second altered name may be included in the database so that the number of new nodes added to the next valid character tree may be minimized. Consequently, the second altered name may be included in the database without needlessly adding new nodes to the next valid character tree. The second name and the second altered name may define the same geographical location, i.e. they may refer to the same geographical location.

In order to find the similarity of names and sounds, allograph lists per language may be used in order to find one or more auxiliary names. Phonemes and/or Levenshtein distance may be used for rating the names. Phonologic Minimal Pair analysis may be used to find one or more auxiliary names. The names may be arranged in an order (of importance) e.g. based on the number of links associated with each name. The names may be arranged in an order (of importance) e.g. based on the number of occurrences of points of interest in points of interest chains for points of interest names.

When a first name may be easily confused with a second name, the next valid character tree may be formed such that a node for selecting a first name may be a sibling of a node for selecting a second name. The order of importance of the first name and the second name may be indicated to the user. The first name and the second name may be presented to the user in the order of importance, so that the name ranked to be of higher importance may be found faster than the similar or identical name ranked to be of lower importance.

In an embodiment, the enhanced next valid character tree may be modified to include auxiliary location names, which are similar but not identical to original location names of a navigation database. An auxiliary name may be a name, which may be easily confused with a name selected by the user. If the user erroneously selects the auxiliary name, the correct name may be displayed simultaneously with the auxiliary name. A comment “did you mean this name” may be optionally displayed.

In an embodiment, the next valid character tree may represent a group of location names, which includes auxiliary names obtainable from a correct location name by making a spelling error and/or a writing error.

In an embodiment, one or more auxiliary location names may be presented (e.g. displayed) in addition to an input name defined by a user. The auxiliary location names may be slightly different from the input name defined by the user. The input name and an auxiliary name may be associated with the same geographical location. The input name and an auxiliary name may be associated with different geographical locations. Thus, the user may have an additional possibility to select a correct name from several displayed names.

Location names may be presented in an order, which may be determined e.g. according to the number of inhabitants, or according to a geographical distance from a location associated with the user-defined input name. In an embodiment, location names may be presented in an order, which may be determined according to auxiliary values associated with the location names. An auxiliary value may specify e.g. a number of inhabitants (e.g. to indicate the size of city), or a typical number of visitors visiting a point of interest during a predetermined time period (e.g. to indicate a popular tourist attraction).

### BRIEF DESCRIPTION OF THE DRAWINGS

In the following examples, various embodiments will be described in more detail with reference to the appended drawings of example embodiments, in which

FIG. 1a shows, by way of example, selecting a next valid character by using a user interface,

FIG. 1b shows, by way of example, defining a point of a route by using the user interface,

FIG. 1c shows, by way of example, a location name expressed by using Cyrillic letters,

FIG. 1d shows, by way of example, selecting a next valid character by using a keys,

FIG. 2 shows, by way of example, a next valid character tree,

FIG. 3 shows, by way of example, representing characters with a grapheme,

FIG. 4a shows, by way of example, an enhanced next valid character tree,

FIG. 4b shows, by way of example, an enhanced next valid character tree,

FIG. 5 shows, by way of example, method steps for adding a new location name to the enhanced next valid character tree,

FIG. 6a shows, by way of example, a next valid character tree, which contains a variant name,

FIG. 6a shows, by way of example, a next valid character tree, which contains pointers to similar but not identical auxiliary names,

FIG. 7 shows, by way of example, units of a navigation device,

FIG. 8 shows, by way of example, a system for providing navigation data,

FIG. 9 shows, by way of example, a navigation device, and

FIG. 10 shows, by way of example, a server for providing navigation data,

### DETAILED DESCRIPTION

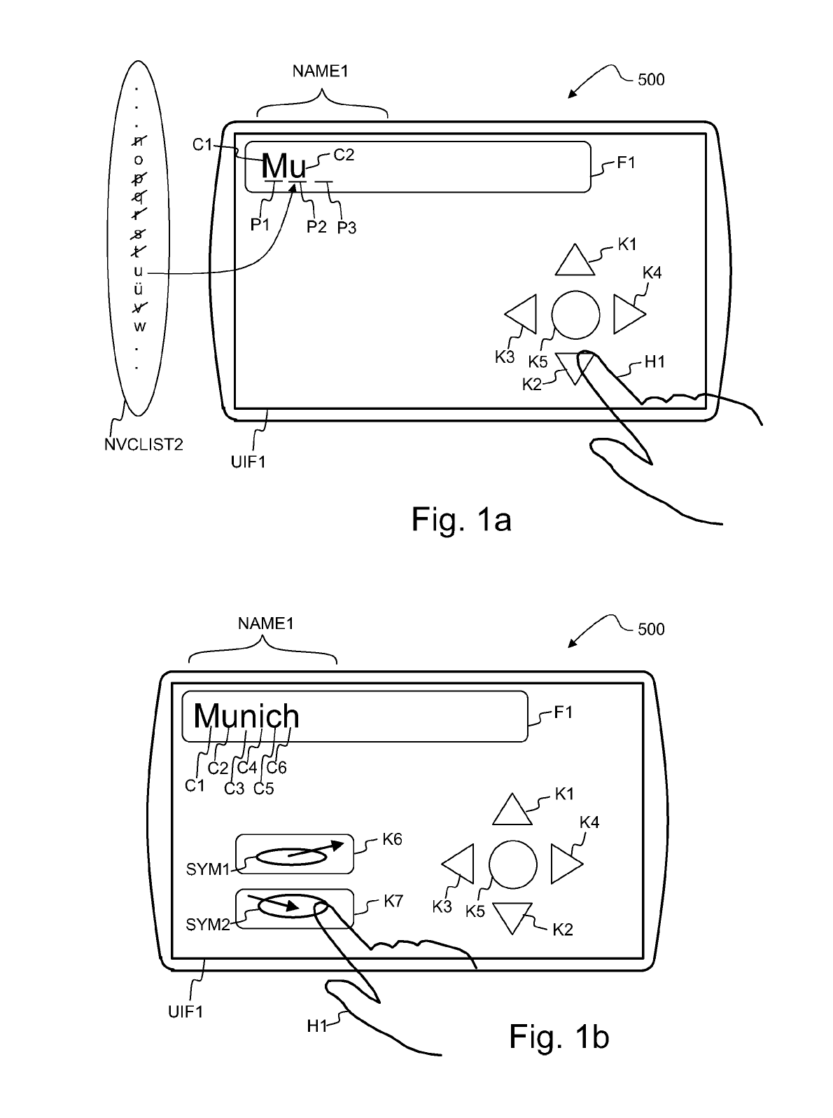

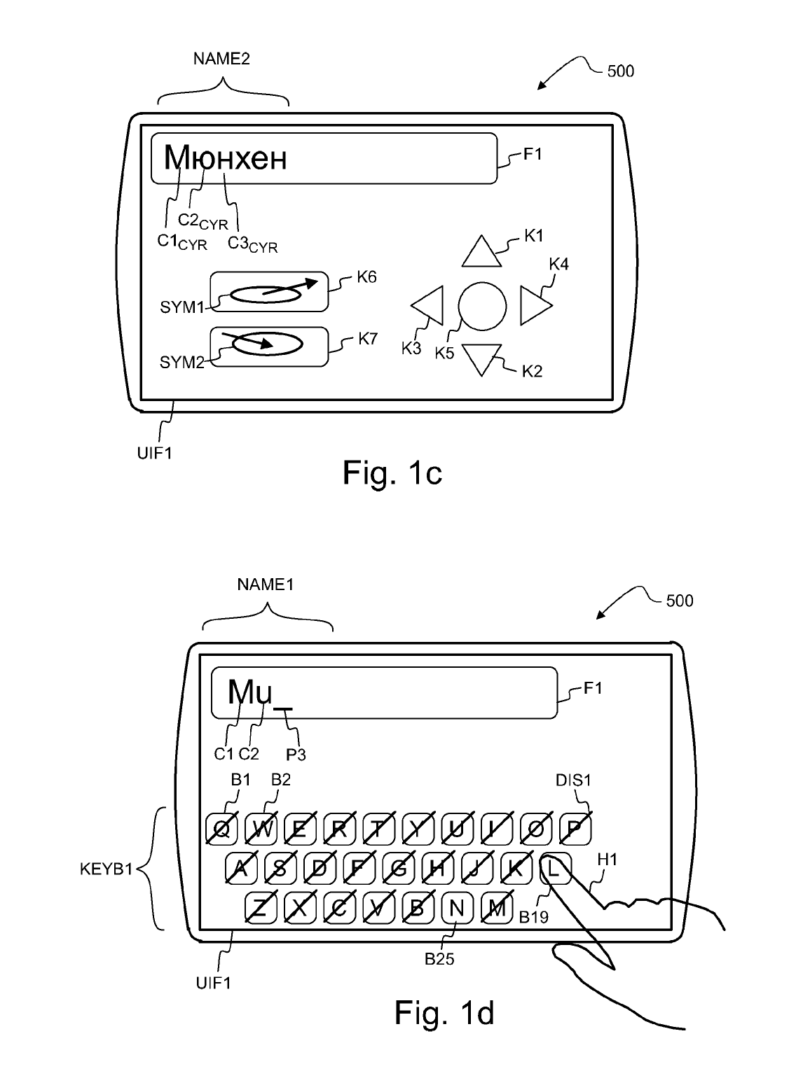

Referring to FIG. 1, a device 500 may be configured to perform e.g. a route search between two locations defined by a first location name and a second location name. The device 500 may be a navigation device. Each location name NAME1 may be a string of characters, i.e. a character string. A location name NAME1 of a location may be inputted by sequentially selecting the characters C1, C2, . . . of the name NAME1. The characters C1, C2 may be selected by using a user interface UIF1 of a device 500. The characters C1, C2 of the name NAME1 may be displayed e.g. in a field F1.

The location name NAME1 may be e.g. the name of a city, the name of a street, the name of an airfield, the name of lake, or the name of a point of interest (e.g. Grand Canyon, Eiffel tower). A location name NAME1 may comprise a number, e.g. a house number. A location name NAME1 may comprise e.g. a postal code.

The user interface UIF1 may be configured to receive character input in a sequential manner. The device 500 may be configured to determine next valid characters for an input word (input substring) received at the user interface UIF1. Said input word (input substring) may comprise one or more previously selected characters. The device 500 may comprise one or more processors coupled to the user interface UIF1 to perform a next valid character search. The processor may be configured to determine, when at least one character input is received at the user interface UIF1, next valid characters by using the next valid character tree. The characters selected by a user may eventually form a search path from the root node to a leaf node.

The device 500 may access and utilize the next valid character tree when a user starts inputting a name NAME1. The device 500 may determine possible next valid characters in response to a substring, which was already entered by a user at the user interface UIF1. The user interface UIF1 may be optionally configured to display one or more next valid character. The user interface UIF1 may be optionally configured to prevent inputting characters which are not included in the list of next valid characters. The device 500 may be configured to start at a root node of the next valid character tree.

In order to aid a user in inputting the name NAME1, the device 500 may be configured to provide information about next valid characters, which are available for selection, and which correspond to a list of valid location names. This may reduce or eliminate a risk that the user inputs a name, which is not contained in the database. For example, the risk of inputting an erroneous name may be reduced by providing information about all next valid characters, which are available for selection. For example, the risk of inputting an erroneous name may be reduced or prevented by limiting the list of characters available for selection, based on information about next valid characters.

The list of valid location names may be associated with a navigation database. The navigation database may comprise a plurality of location names and/or the database may comprise location information associated with a plurality of location names. Each location name may be expressed as a string of characters, i.e. as a character string. A location name may be considered to be valid e.g. when the navigation database comprises location data, which allows associating the location name with geographical position coordinates. An erroneous name may be e.g. a name, which cannot be associated with geographical position coordinates by using the navigation database.

The device 500 may be configured to provide the information about the next valid characters without a substantial delay. The device 500 may be configured to provide the information about the next valid characters while the user is still in the process of inputting the name. The information about the next valid characters may be retrieved quickly by using a next valid character tree. The leaf nodes of the next valid character tree may point e.g. to data base objects. For example, a leaf node may point e.g. to position coordinates associated with an input name, wherein said leaf node and the ancestor nodes of said leaf node may together match said input name.

A character C1 may be selected for the first position P1 of an input name, and a character C2 may be selected for the second position P2 of the input name. A character for a given position of the name (e.g. for the second position P2) may be selected from candidate characters (e.g. o,u,ü, . . . ) contained in a list NVCLIST2 of valid characters. The characters C1, C2 may be selected by using a user interface UIF1. The characters C1, C2 may be selected e.g. by using one or more keys K1, K2. For example, a character C2 displayed in the second position P2 may be changed into the next valid character by using the key K1. For example, a character C2 displayed in the second position P2 may be changed into the previous valid character by using the key K1. The user interface UIF1 may comprise e.g. a touch screen. The user may select the characters C1, C2 e.g. by touching the keys K1, K2 with his finger or hand H1. The keys K1, K2 may also be implemented e.g. in a steering wheel of an automobile. The keys K1, K2 may be implemented e.g. in a joystick. The characters C1, C2 may be selected by using gesture recognition. The characters C1, C2 may be selected by providing verbal instructions, e.g. by saying “next” or “previous”, and by using speech recognition.

The position (e.g. the position P2) of active selection may be optionally indicated e.g. by a blinking cursor, by blinking the character displayed in the position of active selection. The selection of a character may be confirmed e.g. by using the key K4 or key K5. The selection of a character may also be confirmed e.g. by waiting a predetermined period, which may be e.g. in the range of 0.5 s to 10 s. The selection of a character may be cancelled e.g. by using a key K3.

The second character C2 of the name NAME1 may be selected for the position P2 after the first character C1 for the first position P1 has been selected. A third character of the name NAME1 may be selected for the position P3 after the second character C2 for the second position P2 has been selected.

Each position P1, P2, P3 may be associated with a group NVCLIST1, NVCLIST2, NVCLIST3, . . . of valid characters. A group of valid characters may also be called as a list of valid characters. At least one of the lists NVCLIST1, NVCLIST2, NVCLIST3, . . . may contain a reduced set of characters corresponding to the list of location names stored in a navigation database, and corresponding to characters selected for the previous locations. Thanks to using the reduced set of characters, the user may define the name of the location faster. Thanks to using the reduced set of characters, the user may reduce the probability of selecting an erroneous location, which is not contained in the navigation database.

Selecting a character for each position P1, P2, P3 of an input name NAME1 may comprise:

determining a list (NVCLIST1) of valid characters by using the next valid character tree (NVCT1),

receiving user input provided by using one or more keys (K1,K2), and

selecting a character from the list (NVCLIST1) of valid characters based on the user input.

Selecting a character for each position P1, P2, P3 of an input name NAME1 may comprise:

determining a list (NVCLIST1) of valid characters by using the next valid character tree (NVCT1), wherein said list comprises two or more candidate characters,

displaying two or more of said candidate characters,

receiving user input, and

selecting a character from the displayed characters based on the user input.

When displaying characters belonging to a given alphabet system, the number of characters contained in a list NVCLIST1, NVCLIST2, NVCLIST3 may be smaller than the number of different alphabets belonging to said alphabet system. For example, the ISO Basic latin alphabet system has 26 different lower case letters (a,b,c,d,e,f,g,h,i,j,k,l,m,n,o,p,q,r,s,t,u,v,w,x,y,z), and the number of lower case letters contained in the NVCLIST2 may be substantially smaller than 26. For example, the German alphabet system may have 29 lower case letters (a,ä,b,c,d,e,f,g,h,i,j,k,l,m,n,o,ö,p,q,r,s,t,u,ü,v,w,x,y,z). For example, the Greek alphabet system may have 25 lower case letters (α, β, γ, δ, ε, ζ, η, θ, ι, κ, λ, μ, ν, ξ, ο, π, ρ, [symbol] , σ, τ, υ, φ, χ, ψ, ω).

Referring to FIG. 1b, the name NAME1 of the user-selected location may be displayed e.g. on the screen of the user interface UIF1. The name selected by the user may be called e.g. as the input name. The location associated with the input name may be defined to be a point of a route (i.e. a “waypoint”) by using the user interface UIF1. The location may be defined to be a starting point of a route e.g. by using a key K6. The location may be defined to be a destination e.g. by using a key K7. The function of the keys K6, K7 may be indicated e.g. by graphical symbols SYM1, SYM2 and/or by displaying descriptive words (e.g. “start point”, “destination”).

Sometimes the same location may be defined by using different names. For example, different names may be used in different languages to refer to the same geographical location. For example, different ethnic groups may use different names to refer to the same geographical location. The name of a geographical location may also be written by using different alphabet systems.

For example, the location defined by the English name “Munich”, may also be defined by the names München, M [symbol] , Munchov, or Móναχo. These names may refer to the same geographical location. The name “München” may be used e.g. by a person, who is familiar with the German language and/or who wishes to use the German alphabet system. The name M [symbol] may be used e.g. by a person who is familiar with the Russian language, and/or who wishes to use the Cyrillic alphabet system. The name Móναχo may be used e.g. by a Greek person who is familiar with the Greek language, and/or who wishes to use the Greek alphabet system.

C1 may denote a character selected for the first position P1 of the name NAME1. C2 may denote a character selected for the second position P2 of the name. C3 may denote a character selected for the third position P3 of the name. C4, C5, C6 may denote characters selected for the fourth, fifth and sixth positions, respectively.

Referring to FIG. 1c, the user may wish to define the location name NAME2 by using Cyrillic characters C1_{CYR}, C2_{CYR}, C3_{CYR}.

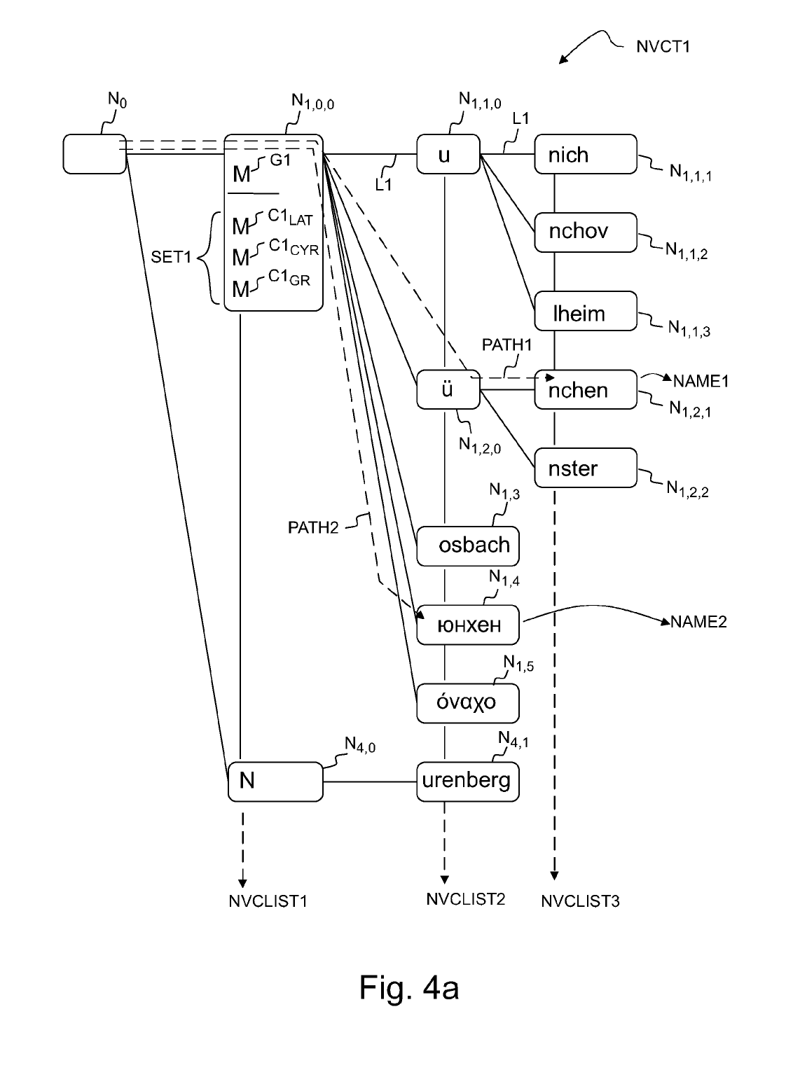

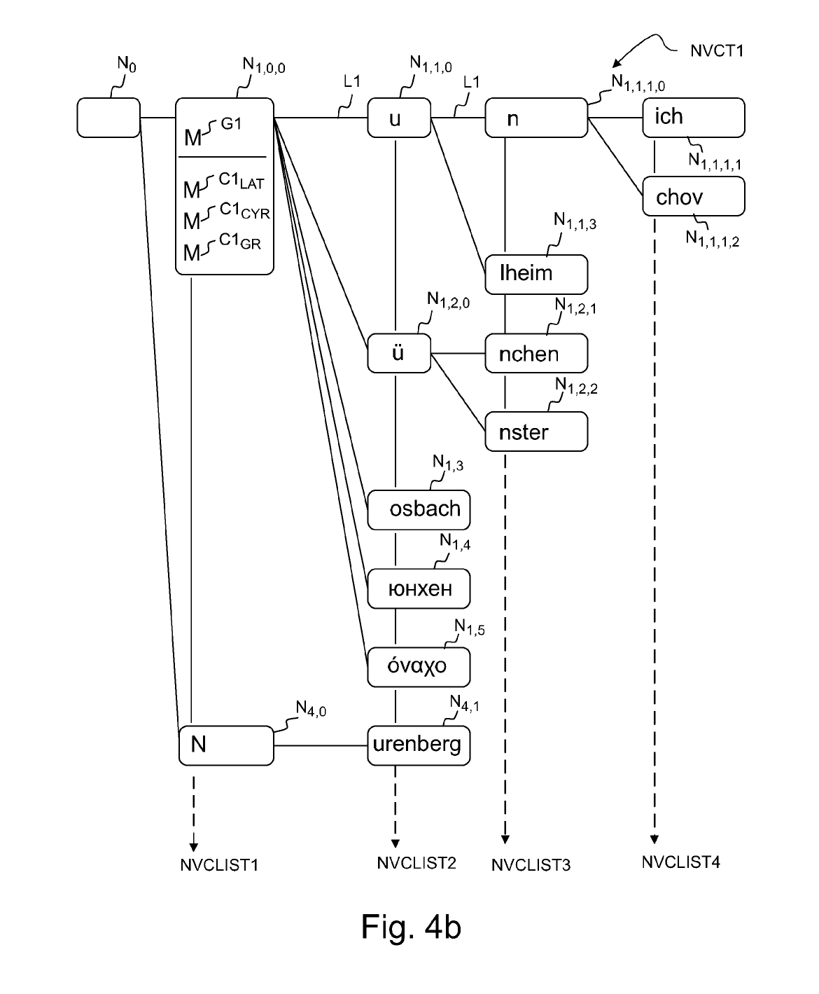

However, the default operating language of the navigation device 500 may be e.g. English, and the default alphabet system may be automatically set according to the default operating language. If the user wishes to define the location name NAME2 by using Cyrillic characters, the user may need to specifically enable the use of the Cyrillic characters and/or the user may need to specifically enable the use of an extended alphabet, which contains Cyrillic characters appended to the Latin characters. Said extended alphabet may contain a high number of characters, and selecting a desired character from said extended alphabet may be time-consuming. Selecting the valid characters may be facilitated by using the extended next valid character tree NVCT1 (see e.g. FIG. 4a).

Referring to FIG. 1d, the user interface UIF1 may also comprise a keyboard KEYB1 for selecting the characters of the location name NAME1, NAME2. One or more keys B19, B25 of the keyboard KEYB1 may be disabled according to the list NVCLIST1, NVCLIST2, NVCLIST3 of valid characters, in order to avoid erroneous selection of a location name, which is not contained in the navigation database. One or more keys B1, B2 of the keyboard KEYB1 may be temporarily disabled according to the list NVCLIST1, NVCLIST2, NVCLIST3 of valid characters, in order to avoid erroneous selection of a location name, which is not contained in the navigation database. Disabled keys may be optionally indicated e.g. by a symbol DIS1 and/or by a color indicator.

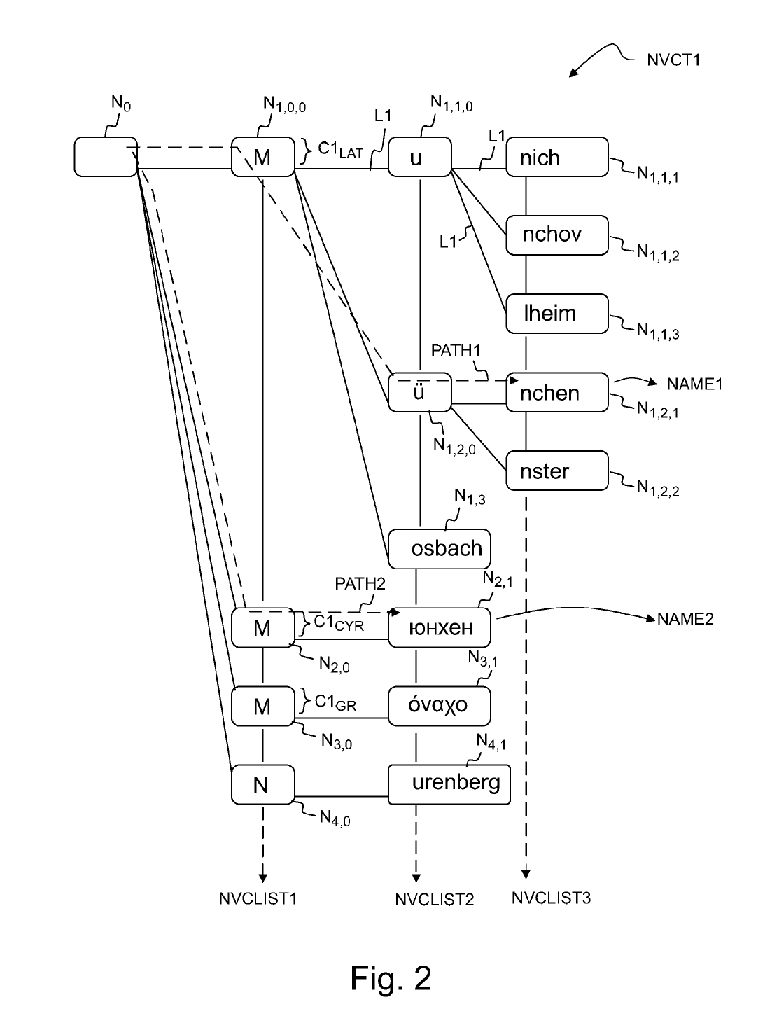

Referring to FIG. 2, a location name contained in the navigation database may be selected by sequentially selecting the characters and/or substrings of said location name. For example, selecting the nodes N₀, N_{1,0,0}, N_{1,2,0}, N_{1,2,1} may cause selecting a location name “München” (NAME1). For example, selecting the nodes N₀, N_{2,0}, N_{2,1} may cause selecting a location name “M [symbol] ” (NAME2). The nodes N₀, N_{1,0,0}, N_{1,2,0}, N_{1,2,1} may together form a first selection path PATH1. The nodes N₀, N_{2,0}, N_{2,1} may together form a second selection path PATH2.

The alternatives presented to the user may be limited according to the next valid character tree. The list NVCLIST1 of valid characters for the first position P1 of a name NAME1 may be determined based on a next valid character tree NVCT1. The list NVCLIST2 of valid characters for the second position P2 of the name NAME1 may be determined based on the next valid character tree NVCT1 and based on the character which was selected for the first position P1. The list NVCLIST3 of valid characters for the third position P3 of the name NAME1 may be determined based on the next valid character tree NVCT1 and based on characters selected for the previous positions P1, P2.

The nodes of the next valid character tree NVCT1 may correspond to different characters (and/or to different substrings). The characters may be alphanumerical characters. Each node may represent a sequence of characters selected by using the user interface UIF1. The child nodes of an ancestor node may represent the possible next valid characters, once said ancestor node has been reached.

The next valid character tree NVCT1 may be formed according to a list of location names contained in the navigation database. The database may include e.g. the following list of location names: Munich, Mulheim, Munchov, München, Münster, Mosbach, M [symbol] , Móναχo, and Nurenberg. The tree NVCT1 may comprise e.g. a node N_{1,0,0}, which may be a place holder for a Latin character, which can be displayed with a grapheme “M”. The node N_{2,0} may be a place holder for a Cyrillic character, which can be displayed with a grapheme “M”. The node N_{3,0} may be a place holder for a Greek character, which can be displayed with a grapheme “M”. The Latin, Cyrillic and Greek characters may be marked with symbols C1_{LAT}, C1_{CYR}, C1_{GR}, respectively. The node N_{4,0} may be a place holder for a Latin character, which can be displayed with a grapheme “N”. The node N_{1,0,0} may be an ancestor node to the child nodes N_{1,1,0}, N_{1,2,0}, N_{1,3}. The node N_{2,0} may be an ancestor node to the child node N_{2,1}. The node N_{3,0} may be an ancestor node to the child node N_{3,1}. The node N_{4,0} may be an ancestor node to the child node N_{4,1}. The node N_{1,1,0} may be an ancestor node to the child nodes N_{1,1,1}, N_{1,1,2}, N_{1,1,3}. The node N_{1,2,0} may be an ancestor node to the child nodes N_{1,2,1}, N_{1,2,2}.

A first name stored in the database may include a first character having a first character code, a second name stored in the database may include a second character having a second character code, wherein the first character and the second character may be represented by the same grapheme (e.g. by the grapheme “M”). A Next Valid Character tree representing the names contained in the navigation database may have two or more different sibling nodes for the same grapheme “M”. In case of FIG. 2, the user may need to enable the use of a different alphabet when he wishes to enter a name “M [symbol] ” instead of the name “Munich”. The user may need to enter a Greek, a Cyrillic, or a Latin character matching the grapheme M.

If the user selects for the first position P1 the Latin character contained in a node (e.g. N_{1,0,0}) the next selection can be made only from among characters represented by the child nodes (e.g. N_{1,1,0}, N_{1,2,0}, N_{1,3}) of said node. If the character represented by the first ancestor node N_{1,0,0} has already been selected, it is not possible to select the character represented by a child node N_{2,1} of the other ancestor node N_{2,0}. Thus, if the user wishes to define the name M [symbol] written with Cyrillic letters, he may need to specifically indicate that the first selected character is a Cyrillic character. This may be time-consuming.

The sibling nodes N_{1,0,0}, N_{2,0}, N_{3,0}, N_{4,0} may be child nodes of a root node N₀. The root node N₀ may also be called as the starting node. In an embodiment, starting a navigation application may cause selecting the starting node N₀. The next valid character tree NVCT1 may indicate next valid characters for a name search, which starts at the root node N₀. An ancestor node may be connected to a child node by a link L1. When an ancestor node is connected to a child node by a link, this means that said ancestor node points to said child node. When an ancestor node is connected to a child node by a link, this means that said ancestor node references to said child node. The link L1 may be called as an edge. The link L1 may be called as a directed edge. The nodes may also be called as vertices. A node which does not have any child nodes may be called as a leaf node.

A next valid character tree NVCT1 may be formed such that the next valid character tree NVCT1 comprises one or more combined nodes. The combined nodes may also be called e.g. as grapheme nodes. The combined nodes may facilitate inputting a first name, which has Latin characters, and subsequently inputting a second name, which has Cyrillic or Greek characters. A next valid character tree NVCT1, which comprises one or more combined nodes may be called e.g. as an enhanced next valid character tree NVCT1. FIG. 4a shows, by way of example, an enhanced next valid character tree NVCT1, which comprises a combined node. The enhanced next valid character tree NVCT1 may be obtained e.g. by modifying the tree shown in FIG. 2.

Generating the enhanced next valid character tree NVCT1 may comprise forming a combined node (N_{1,0,0}), which is a place holder for a first character (C1_{LAT}) having a first character code and a second character (C1_{CYR}) having a second different character code, wherein the first character and the second character are homoglyphs with respect to each other.

The first character and the second character may be homoglyphs with respect to each other e.g. when they have substantially identical visual appearance. The first character and the second character may be homoglyphs with respect to each other e.g. when they have identical visual appearance.

For example, the first character may be e.g. the Latin character “M”, and the second character may be e.g. the Cyrillic character “M”.

For example, the first character may be e.g. the Latin character “H”, and the second character may be e.g. the Cyrillic character “H” (which may phonetically correspond to the Latin character “N”).

For example, the first character may be e.g. the Latin character “X”, and the second character may be e.g. the Greek character “X” (which may phonetically correspond to the Latin character “H”).

For example, the first character may be e.g. “I” (i.e. the lower case character corresponding to the upper case character “L”), and the second character may be e.g. “I” (i.e. the upper case character corresponding to the lower case character “i”).

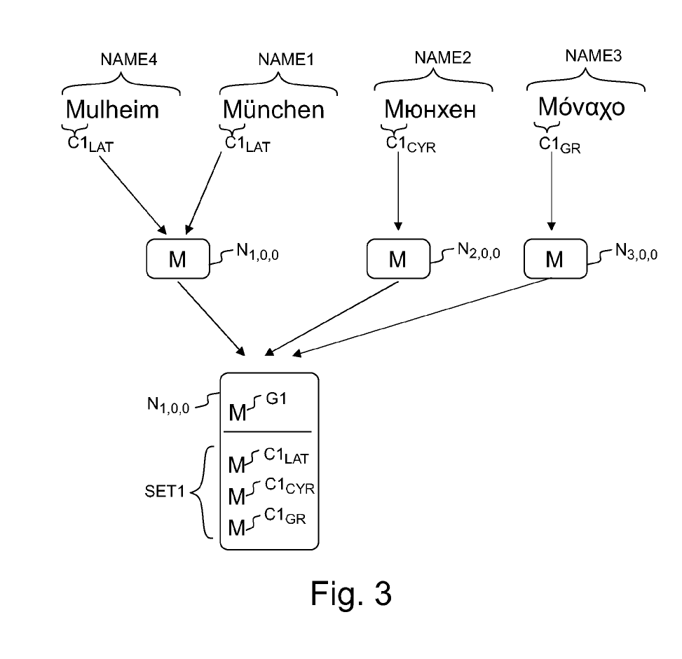

Referring to FIG. 3, a first character (M) in the first position P1 of the name München may be a Latin character, and it may have a first character code. A second character (M) in the first position P1 of the name M [symbol] may be a Cyrillic character, and it may have a second character code, which is different from the first character code. A third character (M) in the first position P1 of the name Móναχo may be a Greek character, and it may have a third character code, which is different from the first character code and the second character code. The first character (M) in the first position P1 of the name Mulheim may be a Latin character, and it may have the first character code.

For example, the character code for the Latin character represented by the homonym M may be 004D, the character code for the Cyrillic character represented by the homonym M may be 041C, and the character code for the Latin character represented by the homonym M may be 039C. For example, the character code for the Latin character represented by the homonym N may be 004E. For example, the character code for the Latin character represented by the homonym H may be 0048, the character code for the Cyrillic character represented by the homonym H may be 041D, and the character code for the Greek character represented by the homonym H may be 0397. The character codes may be expressed e.g. according to the Unicode standard.

A combined node (N_{1,0,0}) of the tree NVCT1 may be formed such that the node is a place holder for the first (Latin) character, for the second (Cyrillic) character, and for the third (Greek) character represented by the same grapheme. The combined node may also be called e.g. as a grapheme node.

The combined node may comprise said grapheme. A combined node (N_{1,0,0}) of the tree NVCT1 may be formed such that the node comprises a grapheme (M), which is a place holder for the first (Latin) character, for the second (Cyrillic) character, and for the third (Greek) character. The combined node may also be called e.g. as a grapheme node.

The combined node (i.e. grapheme node) may point to a first child node and to a second child node, wherein the first child node corresponds to a first substring, which comprises a Latin character, and the second child node corresponds to a second substring, which comprises a Cyrillic or Greek character. A substring may comprise one or more characters. A substring may comprise only one character. A substring may comprise two or more characters.

The combined node N_{1,0,0} may be formed e.g. by combining the nodes N_{2,0} and N_{3,0} into the single node N_{1,0,0} of FIG. 2. The tree NVCT1 comprising the combined node may be formed e.g. by modifying the tree shown in FIG. 2.

Accessing a combined node (N_{1,0,0}) may represent selecting the first (Latin) character, the second (Cyrillic) character, and the third (Greek) character. Accessing said combined node (N_{1,0,0}) may represent selecting a group SET1 of characters, wherein said group SET1 comprises the first (Latin) character, the second (Cyrillic) character, and the third (Greek) character.

Referring to FIG. 4a, an enhanced next valid character tree NVCT1 may comprise one or more combined nodes (i.e. grapheme nodes).

For example, selecting the nodes N₀, N_{1,0,0}, N_{1,2,0}, N_{1,2,1} may cause selecting a location name “München” (NAME1). For example, selecting the nodes N₀, N_{1,0,,0}, N_{1,4} may cause selecting a location name “M [symbol] ” (NAME2). The nodes N₀, N_{1,0,,0}, N_{1,2,0}, N_{1,2,1} may together form a first selection path PATH1. The nodes N₀, N_{1,0,,0}, N_{1,4} may together form a second selection path PATH2.

The list NVCLIST1 of valid characters for the first position P1 of a name NAME1 may be determined based on an enhanced next valid character tree NVCT1. The list NVCLIST2 of valid characters for the second position P2 of the name NAME1 may be determined based on the enhanced next valid character tree NVCT1 and based on the character which was selected for the first position P1. The list NVCLIST3 of valid characters for the third position P3 of the name NAME1 may be determined based on the enhanced next valid character tree NVCT1 and based on characters selected for the previous positions P1, P2.

The enhanced next valid character tree NVCT1 may comprise nodes for selecting a location name NAME1 from a group of different location names, wherein said group may comprise e.g. more than 100 location names, more than 1000 location names, or even more than 10000 location names. The navigation database may comprise e.g. more than 100 location names, more than 1000 location names, or even more than 10000 location names.

The enhanced next valid character tree NVCT1 may be formed according to a list of location names contained in the navigation database. The database may contain e.g. the following location names: Munich, Mulheim, Munchov, München, Münster, Mosbach, M [symbol] , Móναχo, and Nurenberg. The tree NVCT1 may comprise e.g. a combined node, which may be a place holder for two or more characters, which are homonyms (i.e. they look the same), but which have different character codes. For example, the ancestor node N_{1,0,0} may be a combined node. The node N_{1,0,0} may be a place holder for a Latin character, for a Cyrillic character, and for a Greek character, which can be displayed with a grapheme “M”. The grapheme may be marked with a symbol G1. The Latin, Cyrillic and Greek characters may be marked with symbols C1_{LAT}, C¹_{CYR}, C¹ _{GR}, respectively.

The node N_{4,0} may be a place holder for a Latin character, which can be displayed with a grapheme “N”. The node N_{1,0,0} may be an ancestor node to the child nodes N_{1,1,0}, N_{1,2,0}, N_{1,3}, N_{1,4}, N_{1,5}. The node N_{4,0} may be an ancestor node to the child node N_{4,1}. The node N_{1,1,0} may be an ancestor node to the child nodes N_{1,1,1}, N_{1,1,2}, N_{1,1,3}. The node N_{1,2,0} may be an ancestor node to the child nodes N_{1,2,1}, N_{1,2,2}.

If the user selects for the first position P1 a character represented by the grapheme G1 of an ancestor node (e.g. N_{1,0,0}), the next selection can be made from among the characters represented by the child nodes (e.g. N_{1,1,0}, N_{1,2,0}, N_{1,3}, N_{1,4}, N_{1,5}) of said ancestor node. Thanks to the combined node, the user may select for the second position P2 a character, which is Latin character, Cyrillic character, or a Greek character.

The user may select from two or more alternatives displayed on a screen UIF1. A combined node of the tree NVCT1 may be a place holder for a Latin character, a Cyrillic character, and a Greek character in a situation where the Latin character, the Cyrillic character, and the Greek character may be represented by the same grapheme. When displaying an alternative, which is represented by the combined node, it may be enough to display only the Latin character, only the Cyrillic character, or only the Greek character. In other words, it is not necessary to represent the grapheme by a code, which is different from the character codes of the Latin character, the Cyrillic character, and the Greek character. Yet, the combined node may represent a grapheme, but it does not need to comprise a grapheme.

Thus, the user may select the name Munich written with Latin letters, the name M [symbol] written with Cyrillic letters, or the name Móναχo written with Greek letters without indicating in advance that he intends to use a certain alphabet system.

A location name may be selected by a method, which comprises:

determining a list NVCLIST1 of valid characters by accessing a next valid character tree NVCT1, and

selecting an input character from said list NVCLIST1 of valid characters based on user input,

wherein said next valid character tree NVCT1 comprises:

a first set of nodes for selecting a first name NAME1, the first name comprising a first character C1_{LAT} represented by a first character code,

a second set of nodes for selecting a second name NAME2, the second name comprising a second character C1_{CYR} represented by a second character code, wherein the first character and the second character are homoglyphs with respect to each other, and said next valid character tree NVCT1 comprises a combined node N_{1,0,0}, which is a place holder for the first character C1_{LAT} and for the second character C1_{CYR}.

The user input may be provided via the user interface UIF1. The user input may be provided e.g. by using one or more keys K1, K2. The user input may be provided e.g. by using a touch screen.

The first character may belong to a first alphabet, the second character may belong to a second different alphabet, and the first alphabet and the second alphabet are selected from a group consisting of Latin alphabet, Cyrillic alphabet, and Greek alphabet.

The characters may be selected in sequential order, and the list of valid characters for a position may depend on characters selected for the previous positions. A location name may be selected by a method, which comprises:

selecting a first input character from a first list NVCLIST1 of valid characters based on first user input,

determining a second list of valid characters based on the first input character by accessing said next valid character tree NVCT1, and

selecting a second input character from said second list NVCLIST2 of valid characters based on second user input.

Several location names may be consecutively selected by a method, which comprises:

receiving a first user input, which causes selecting the first name NAME1 by accessing at least said combined node N_{1,0,0} and a first child node of said combined node N_{1,0,0}, and

receiving a second user input, which causes selecting the second name NAME2 by accessing at least said combined node N_{1,0,0} and a second child node of said combined node N_{1,0,0}.

Two or more different characters may be simultaneously represented by the same grapheme G1. Selecting said grapheme G1 may mean selecting said two or more characters for a given position (e.g. for the position P1). Selecting said grapheme G1 may represent selecting a group SET1, which comprises two or more characters. When a first character belonging to the group SET1 is selected for a first position P1, this may cause selecting also the other characters of said group SET1 for said first position P1. All characters of the group SET1 may be temporarily (i.e. provisionally) selected for the first position P1. Selecting a character for the second position P2 may cause that only one of the characters of the group SET1 is finally (and retroactively) selected for the first position P1. Accessing a leaf node (e.g. N_{1,2,1} or N_{1,4}) of the tree NVCT1 may cause that only one of the characters of the group SET1 is finally selected for the first position P1.

A combined node N_{1,0,0} may be a place holder for a first Latin character C1_{LAT} (e.g. “M”) and for a second Cyrillic character C1_{CYR} (“M”). Selecting the Latin character C1_{LAT} for the first position P1 may mean that also the Cyrillic character C1_{CYR} is temporarily selected for the first position P1. Selecting a Cyrillic character (e.g. “ [symbol] ”) for the next position P2 may cause that only the Cyrillic character C1_{CYR} (“M”) is finally selected for the first position P1. Thus, selecting a character for the next position P2 may eliminate one or more characters from the group SET1, which was temporarily selected for the previous position P1. Selecting a character for the next position P2 may cause that only one character of the group SET1 is finally selected for the first (previous) position P1. The device 500 may be configured to operate such that if the user selects an input name by inputting at least one character which belongs to an alphabet, all characters of said input name may be determined to belong to the same alphabet.

The characters of the group SET1 may be simultaneously represented by the combined node. Selecting a character may mean selecting all characters represented by the combined node. Selecting a character represented by a combined node (i.e. grapheme node) may mean that several characters are temporarily selected for the given position (e.g. P1). The device 500 may be configured to operate such that selecting a character for the next position (e.g. P2) causes that only one character of the group SET1 is finally selected for the first position P1. The device 500 may be configured to operate such that accessing a leaf node causes that only one character of the group SET1 is finally selected for the first position P1. When the next character belongs to an alphabet, the device 500 may be configured to determine that also the previous character belongs to said alphabet. For example, if a character selected for the second position P2 is a Cyrillic character, the Cyrillic character C1_{CYR} of the group SET1 may be selected also for the previous position P1.

A leaf node (e.g. N_{1,4} or N_{1,2,1}) may comprise one or more characters belonging to an alphabet selected from Latin, Cyrillic and Greek alphabet. The device 500 may be configured to operate such that accessing said leaf node (e.g. N_{1,4} or N_{1,2,1}) causes determining that all previous characters of the selected name belong to the same alphabet as the characters of said leaf node.

The next valid character tree NVCT1 may be implemented as a part of a data structure. The data structure may be stored on a non-transitory computer-readable medium.

The data structure may comprise a next valid character tree (NVCT1), which when accessed by one or more processors:

defines a set (NVCLIST1) of characters available for selection, and

enables selecting a name from a group of names according to a character selected from said set (NVCLIST1) of characters,

wherein said group of names includes a first name (NAME1) and a the second name (NAME2), and said next valid character tree (NVCT1) comprises:

a first set of nodes for selecting the first name (NAME1), the first name comprising a first character (C1_{LAT}) represented by a first character code,

a second set of nodes for selecting the second name (NAME2), the second name comprising a second character (C1_{CYR}) represented by a second character code,

wherein the first character and the second character are homoglyphs with respect to each other, and said next valid character tree (NVCT1) comprises a combined node (N_{1,0,0}), which is a place holder for the first character (C1_{LAT}) and for the second character (C1_{CYR}).

The next valid character tree NVCT1 may also be optionally modified, e.g. in order to facilitate search and/or in order to minimize usage of memory space. One or more nodes of the tree NVCT1 may be optionally divided into ancestor nodes and child nodes in order to facilitate selecting an input name. If the user has previously selected the nodes N_{1,0,0} and N_{1,1,0} in FIG. 4a, he may make a selection from among the nodes N_{1,1,1}, N_{1,1,2}, N_{1,1,3}. The character strings of the nodes N_{1,1,1}, N_{1,1,3} may start with the same character. For example, the character strings “nich” and “nchov” start with the same character n.

As shown in FIG. 4b, the node N_{1,1,1} of FIG. 4a representing the character string “nich” may be divided into an ancestor node N_{1,1,1,0} representing the string “n”, and into a child node N_{1,1,1,1} representing the character string “ich”. The node N_{1,1,2} of FIG. 4a representing the character string “nchov” may be divided into the ancestor node N_{1,1,1,0} representing the string “n”, and into a child node N_{1,1,1,2} representing the character string “chov”. A node of the tree NVCT1 may be optionally divided e.g. in order to reduce the number of characters contained in a list NVCLIST3 of valid characters. A node of the tree NVCT1 may be optionally divided e.g. in order to reduce the time needed to select all characters of an input name.

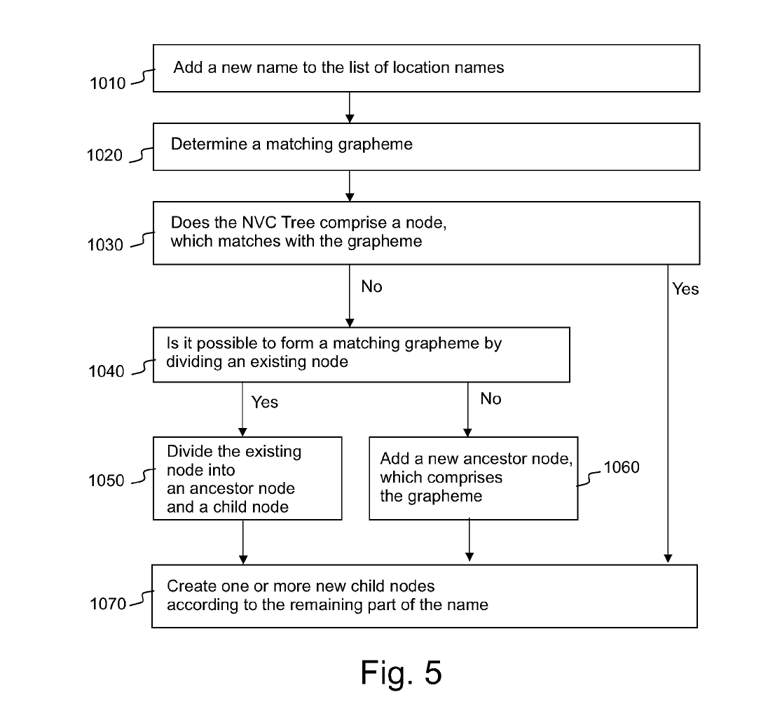

FIG. 5 shows method steps for generating a tree NVCT1. In step 1010, a new name may be added to a list of location names. The list may contain substantially all location names associated with a navigation database. In step 1020, a grapheme matching with a character of the new name may be determined. In step 1030, it may be checked whether the existing tree already contains a node, which matches with the determined grapheme.

If the tree already contains a node, which matches with the determined grapheme, a new child node may be added to the tree in step 1070 such that the matching node is an ancestor node of the child node. If the matching node is not yet a grapheme node, it may be converted into a grapheme node.

If the tree does not yet contain a node, which matches with the determined grapheme, a new grapheme node matching with the determined grapheme may be added to the tree in step 1060.

Sometimes an existing node may be divided into an ancestor node and a child node such that the ancestor node matches with the determined grapheme. In an optional step 1040, it may be checked whether the tree contains a node, which can be divided into an ancestor node and a child node such that the ancestor node matches with the determined grapheme.

The node may be divided into an ancestor node and a child node such that the ancestor node matches with the determined grapheme in step 1050, if this is possible.

If the node cannot be divided into an ancestor node and a child node such that the ancestor node matches with the determined grapheme, a new grapheme node matching with the determined grapheme may be added to the tree in step 1060.

The steps mentioned above may be repeated each time when a new name is added to the navigation database in order to update the enhanced next valid character tree NVCT1, respectively.

The method may be carried out automatically by a data processor when preparing a database for use in a navigation device. The method may be carried out automatically by a data processor when a new name is added to the database and/or when a name is removed from the database.

In an embodiment, inputting a character string NAME1 may comprise selecting a substring from a list of valid alternatives. The substring may comprise two or more characters. The list of valid alternatives may comprise individual characters and/or substrings. A list of valid alternatives may include e.g. a substring “ue”, a character ü, and a character “y”. The list of valid alternatives may be determined by using a next valid character tree.

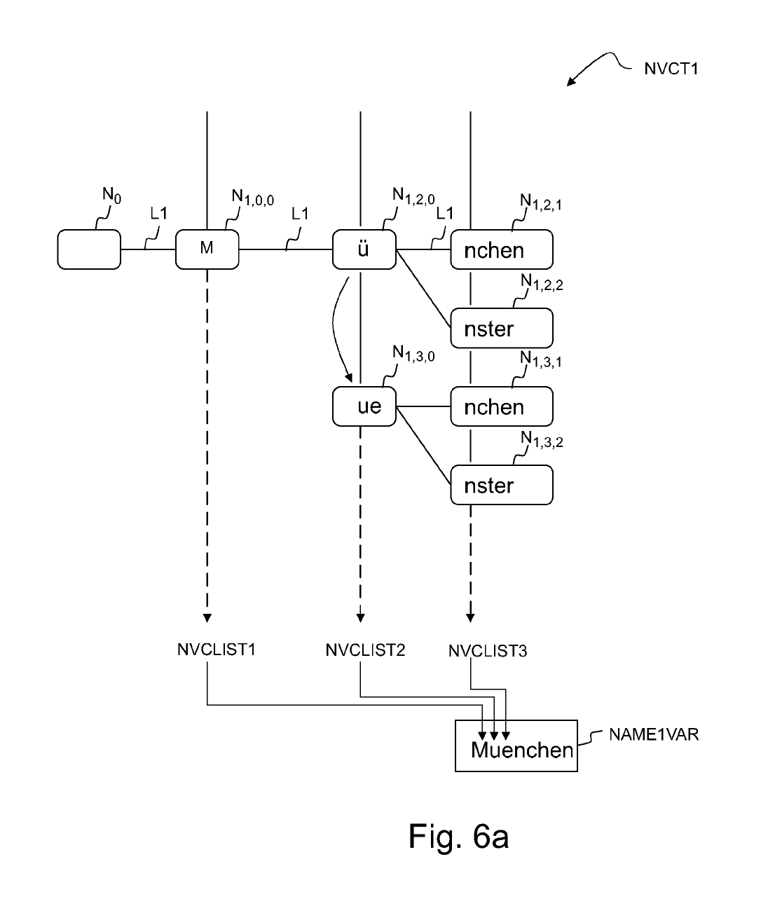

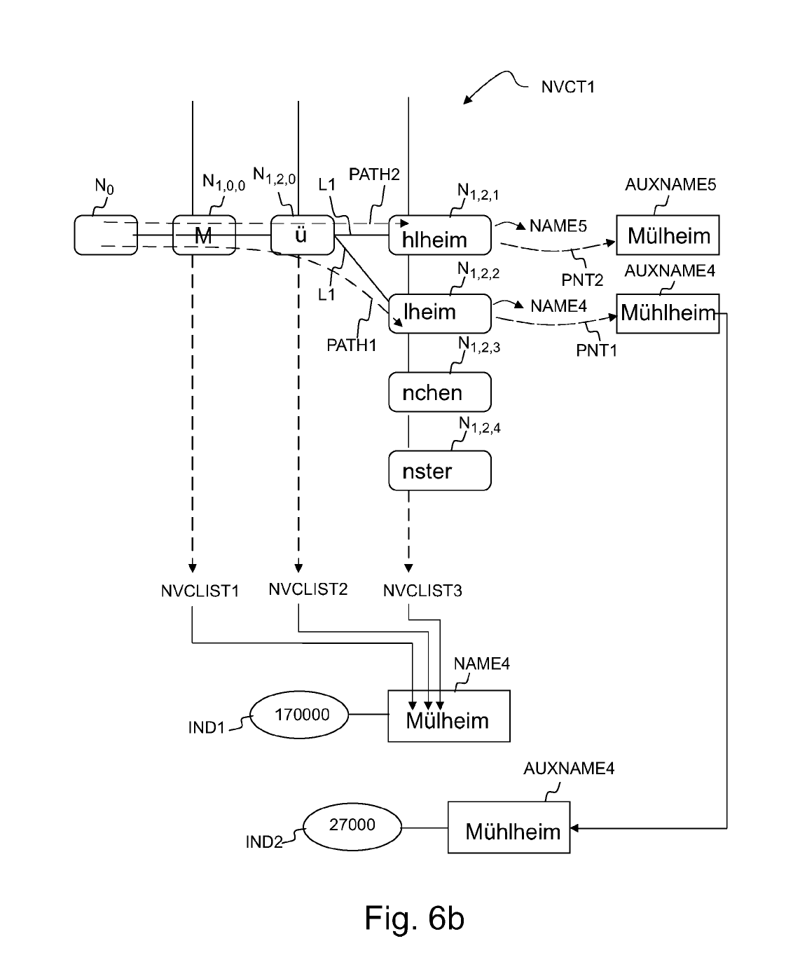

FIG. 6a shows generating a next valid character tree NVCT1, which contains nodes representing one or more allographic variants NAME1VAR of a location name NAME1. For example, the next valid character tree NVCT1 may contain nodes representing a first name “München”, and the next valid character tree NVCT1 may also contain nodes representing the variant name “Muenchen”. The first name and the second variant name may be associated with the same geographical location. The second name “Muenchen” may be an allographic variant of the first name “München”. The substring “ue” may be an allograph of the character “ü” in terms of pronunciation. The first name may contain a first substring, and the second allographic variant name may contain a second substring such that the first substring and the second substring represent the same phoneme. A first character (or a first character substring) and a second character (or a second character substring) may herein be allographs, which represent the same phoneme. For example, the substrings “ü” and “ue” may represent the same phoneme.

A navigation apparatus may be configured to generate one or more allographic variants of a first name, and to add one or more nodes and one or more links to the next valid character tree NVCT1, respectively. The variant name may be generated e.g. by using an auxiliary database, which contains information about characters and substrings which are allographs.

The method may comprise:

providing a variant name (NAME1VAR) by replacing a first substring of the first name (NAME1) with a second different substring such that the first substring and the second substring represent the same phoneme, and

updating the next valid character tree (NVCT1) according to the variant name (NAME1VAR) such that the next valid character tree (NVCT1) comprise nodes for selecting the first name (NAME1) and nodes for selecting the variant name (NAME1VAR).

The method may comprise:

providing a variant name (NAME1VAR) by replacing a first grapheme of the first name (NAME1) with a second grapheme such that the first grapheme and the second grapheme correspond to the same sound, and

updating the next valid character tree (NVCT1) according to the variant name (NAME1VAR) such that the next valid character tree (NVCT1) comprise nodes for selecting the first name (NAME1) and nodes for selecting the variant name (NAME1 VAR).

For example, a navigation apparatus may automatically generate the variant name “Muenchen” based on the first name “München”, and the navigation apparatus may automatically update the next valid character tree according to the variant name. Inputting the variant name “Muenchen” may be easier e.g. for an English-speaking user, who is perhaps not familiar with the character “ü”.

The first name NAME1 may be optionally associated with a first indicator value, which indicates that the first name NAME1 is a recommended name, and the variant name NAME1VAR may be associated with a second indicator value, which indicates that the variant name NAME1VAR is an alternative name.

The next valid character tree NVCT1, which contains nodes for the variant name, may also be an enhanced next valid character tree NVCT1, i.e. it may also contain one or more combined nodes (i.e. grapheme nodes).

The method may comprise:

providing a variant name (NAME1VAR) based on the first name (NAME1) such that the variant name (NAME1VAR) contains an allograph of a grapheme of the first name (NAME1), and

updating the next valid character tree (NVCT1) according to the variant name (NAME1VAR) such that the next valid character tree (NVCT1) comprise nodes for selecting the first name (NAME1) and nodes for selecting the variant name (NAME1 VAR).

FIG. 6b shows a next valid character tree NVCT1, which contains nodes for selecting similar but not identical location names. A human user may sometimes confuse a first name with a second name when the second name is similar but not identical to the first name. For example, the name “Mülheim” may be easily confused with the name “Mühlheim”.

A next valid character tree NVCT1 may contain nodes for a first location name NAME4 and for a second location name NAME5. The location names NAME4, NAME5 may be similar but not identical. For example, selecting the nodes N₀, N_{1,0,0}, N_{1,2,0}, N_{1,2,2} may cause selecting a location name “Mülheim” (NAME4). For example selecting the nodes N₀, N_{1,0,0}, N_{1,2,0}, N_{1,2,1} may cause selecting a location name “Mühlheim” (NAME5). The nodes N₀, N_{1,0,0}, N_{1,2,0}, N_{1,2,2} may together form a first selection path PATH1. The nodes N₀, N_{1,0,0}, N_{1,2,0}, N_{1,2,1} may together form a second selection path PATH2.

The location names NAME4, NAME5 may refer to different geographical locations. For example, the first name “Mülheim” (NAME4) may refer to a city, which has 170000 inhabitants, and the second name “Mühlheim” (NAME5) may refer to a smaller town, which has 27000 inhabitants. The second name “Mühlheim” may be used as an auxiliary name AUXNAME4 for the first name “Mülheim”. The first name “Mülheim” may be used as an auxiliary name AUXNAME5 for the second name “Mühlheim”. The leaf node N_{1,2,1} corresponding to the second name “Mühlheim” may have an auxiliary pointer PNT2, which points to the auxiliary name “Mülheim”. The leaf node N_{1,2,2} corresponding to the first name “Mülheim” may have an auxiliary pointer PNT1, which points to the auxiliary name “Mühlheim”.

Now, when the user inputs the first name “Mülheim”, the apparatus may be configured to display the auxiliary name “Mühlheim” of said first name by using the auxiliary pointer PNT1. The apparatus may be configured to display the auxiliary name “Mühlheim” together with a message, e.g. together with a question “Did you mean this?”. The user may subsequently select the auxiliary name “Mühlheim” instead of the first name “Mülheim”.

The names NAME4 and AUXNAME4 may be associated with indicator values IND1, IND2. The names may be displayed in an order determined based on the indicator values IND1, IND2. An indicator value may indicate e.g. the number of inhabitants, or an average number of tourists visiting a location during one year.

When inputting a name by using the next valid character tree NVCT1, a first candidate name NAME4 may be associated with a first indicator value IND1, and a second candidate name AUXNAME4 may be associated with a second indicator value IND2, wherein the method may comprise displaying at least a part of the first candidate name NAME4 and at least a part of the second candidate name AUXNAME4 in an order, which is determined by the first indicator value IND1 and by the second indicator value IND2.

The next valid character tree NVCT1, which contains pointers to the auxiliary names, may also be an enhanced next valid character tree NVCT1, i.e. it may also contain one or more combined nodes (i.e. grapheme nodes).

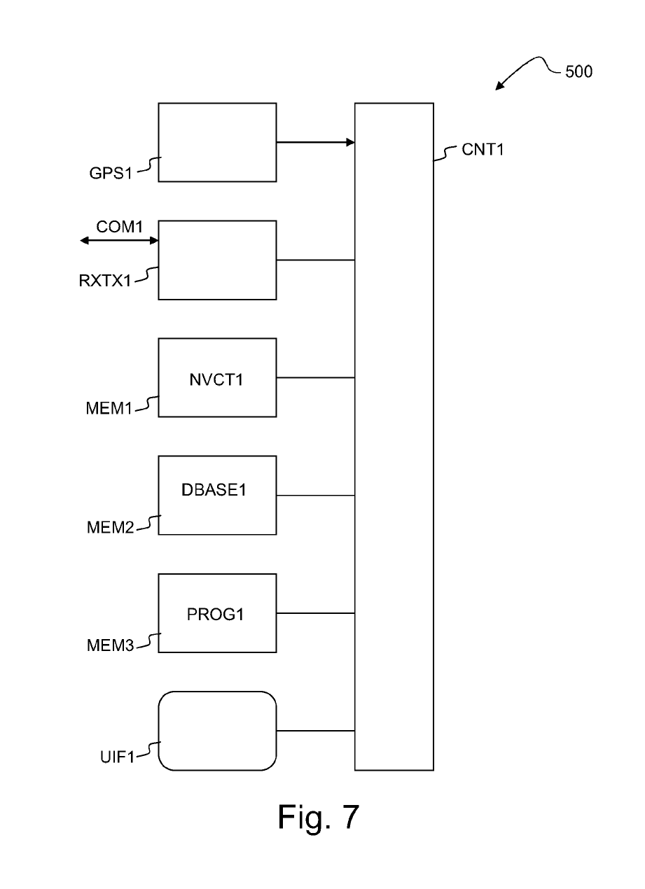

FIG. 7 shows functional units of a navigation apparatus 500. The navigation apparatus may be a device 500. The navigation apparatus may be a portable device 500. The device 500 may be e.g. a mobile device attached to an automobile or a boat.

The device 500 may comprise a memory MEM2 for storing a navigation database DBASE1. The database DBASE1 may comprise e.g. a plurality of names associated with geographic locations. The database DBASE1 may comprise location data specifying the geographic location associated with each name. The location data may be specified e.g. by GPS coordinates. GPS denotes Global Positioning (Satellite) System. The names may be specified e.g. by character strings. The database DBASE1 may comprise a digital map.

The device 500 may comprise a memory MEM1 for storing a next valid character tree NVCT1, which may substantially correspond to the location names of the navigation database DBASE1. The next valid character tree NVCT1 may be updated when one or more new names are added to the database DBASE1 and/or when one or more new names are removed from the database DBASE1. The next valid character tree NVCT1 stored in the memory MEM1 may comprise one or more combined nodes, i.e. it may be an enhanced next valid character tree NVCT1.

The device 500 may comprise a user interface UIF1 for selecting an input name from among candidate names included in the database DBASE1. The user interface UIF1 may comprise e.g. a touch screen. The user interface UIF1 may comprise e.g. a keypad. The user interface UIF1 may comprise e.g. a one or more keys K1, K2. The user interface UIF1 may comprise e.g. a display for displaying selected characters. A part of the user interface UIF1 may be integrated in an automobile. In particular, one or more selection keys K1, K2 may be integrated in the steering wheel and/or in the dashboard of an automobile.

The device 500 may comprise a communication unit RXTX1 for receiving data COM1 from a web (e.g. Internet), local area network and/or mobile communications network.

The device 500 may comprise a control unit CNT1 for controlling operation of the device 500. The control unit CNT1 may comprise one or more data processors. io The control unit CNT1 may be configured to e.g. update the tree NVCT1, to update the database DBASE1 and/or to controlling operation of the user interface UIF1 during selecting an input name.

The device 500 may comprise a memory MEM3 for storing computer program code PROG1. The computer program code PROG1, when executed by one or more data processors, may be for generating the tree NVCT1 and/or for controlling operation of the device 500.

The device 500 may optionally comprise a navigation unit GPS1. The navigation unit GPS1 may also be called as a position sensor. The position sensor GPS1 may be arranged to detect (i.e. measure) the actual location of the device 500. The position sensor GPS1 may be a satellite navigation device. The position sensor may be arranged to determine the position of the device 500. The position sensor GPS1 may determine the position of the device 500 by satellite navigation. The position sensor GPS1 may determine the position of the device 500 e.g. based on the proximity of an antenna of a mobile telecommunication network.

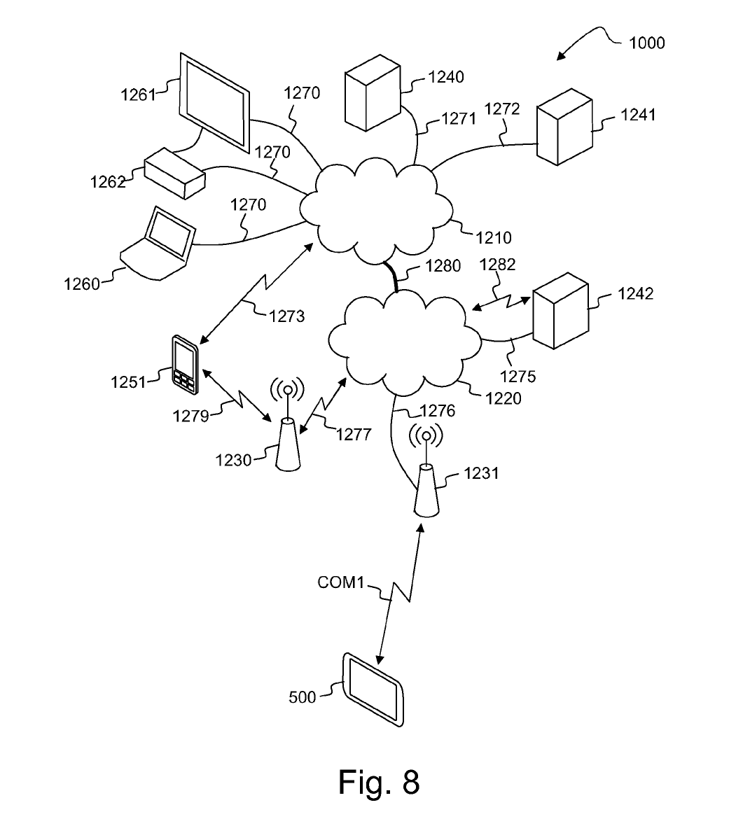

FIG. 8 shows, by way of example, a distributed system 1000 for updating navigation data, for generating a next valid character tree, and/or for using the navigation data. The system 1000 may comprise a plurality of devices arranged to communicate with each other. The system 1000 may comprise a navigation device 500. The seeking device 500 may comprise a user interface UIF1 for selecting a location name by using a next valid character tree NVCT1. The navigation device 500 or a server 1240, 1241, 1242 may comprise one or more data processors configured to update and/or use navigation data DBASE1.

The system 1000 may comprise end-user devices such as one or more navigation devices 500, mobile phones or smart phones 1251, Internet access devices (Internet tablets), personal computers 1260, a display or an image projector 1261 (e.g. a television), and/or a video player 1262. A mobile phone, a smart phone, an Internet access device, or a personal computer may comprise an interface UIF1 for selecting a location name by using a next valid character tree NVCT1. A server, a mobile phone, a smart phone, an Internet access device, or a personal computer may be arranged to distribute database data DBASE1 and/or data for updating a next valid character tree NVCT1. Distribution and/or storing the data DBASE1, NVCT1 may be implemented in the network service framework with one or more servers 1240, 1241, 1242 and one or more user devices. As shown in the example of FIG. 8, the different devices of the system 1000 may be connected via a fixed network 1210 such as the Internet or a local area network (LAN). The devices may be connected via a mobile communication network 1220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks may be connected to each other by means of a communication interface 1280. A network (1210 and/or 1220) may comprise network elements such as routers and switches to handle data (not shown). A network may comprise communication interfaces such as one or more base stations 1230 and 1231 to provide access for the different devices to the network. The base stations 1230, 1231 may themselves be connected to the mobile communications network 1220 via a fixed connection 1276 and/or via a wireless connection 1277. There may be a number of servers connected to the network.

For example, a server 1240 for providing a network service such as a social media service may be connected to the network 1210. A second server 1241 for providing a network service may be connected to the network 1210. A server 1242 for providing a network service may be connected to the mobile communications network 1220. Some of the above devices, for example the servers 1240, 1241, 1242 may be arranged such that they make up the Internet with the communication elements residing in the network 1210. The devices 500, 1251, 1260, 1261, 1262 can also be made of multiple parts. One or more devices may be connected to the networks 1210, 1220 via a wireless connection 1273. Communication COM1 between a navigation device 500 and a second device of the system 1000 may be fixed and/or wireless. Communication COM1 between the user interface UIF1 and the control unit CNT1 of the device 500 may be fixed and/or wireless. One or more devices may be connected to the networks 1210, 1220 via communication connections such as a fixed connection 1270, 1271, 1272 and 1280. One or more devices may be connected to the Internet via a wireless connection 1273. One or more devices may be connected to the mobile network 1220 via a fixed connection 1275. A device 500, 1251 may be connected to the mobile network 1220 via a wireless connection COM1, 1279 and/or 1282. The connections 1271 to 1282 may be implemented by means of communication interfaces at the respective ends of the communication connection. A user device 500, 1251 or 1260 may also act as web service server, just like the various io network devices 1240, 1241 and 1242. The functions of this web service server may be distributed across multiple devices. Application elements and libraries may be implemented as software components residing on one device. Alternatively, the software components may be distributed across several devices. The software components may be distributed across several devices so as to form a cloud.

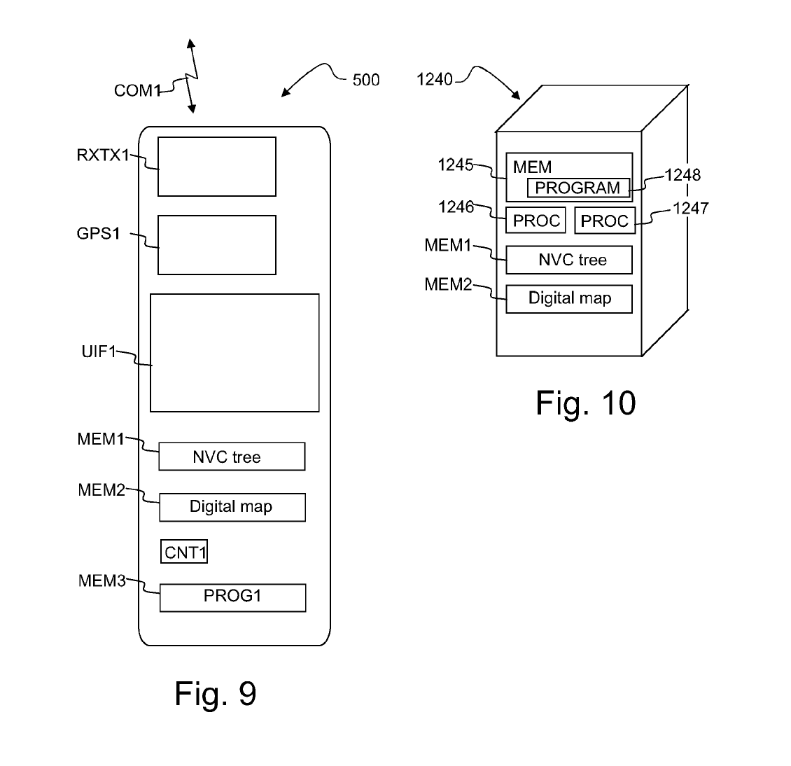

FIG. 9 shows a portable and/or mobile navigation device 500, which may be configured to generate, update and/or use the data DBASE1, NVCT1. The device 500 may be e.g. a navigation device, a mobile phone, a smartphone, a communicator, a portable computer, a camera, or a personal digital assistant (PDA). The device 500 may comprise a memory MEM1 for storing tree data NVCT1 and a memory MEM2 for storing navigation database data DBASE1. The navigation database DBASE1 may comprise e.g. a digital map of a geographical area. The device 500 may comprise the user interface UIF1, one or more processors CNT1, a memory MEM3 for storing computer program PROG1. The device 500 may comprise a communication unit RXTX1 for receiving data DBASE1, NVCT1 wirelessly e.g. from the Internet 1210, and/or from a mobile telephone network 1220.

The device 500 may further comprise one or more microphones for converting sound waves into audio signals. The device 500 may further comprise one or more speakers for reproducing audio signals. A microphone may be used e.g. to implement a mobile phone functionality.

FIG. 10 shows a server 1240, which may comprise a memory 1245, one or more processors 1246, 1247, and computer program code 1248 residing in the memory 1245 for implementing, for example, a service for distributing and/or updating the data DBASE1, NVCT1.

The next valid character trees mentioned in the context of FIGS. 1a, 1b, 1c, 1d, 3, 4a, 4b, 5, 6a, 6b, 7, 8, 9 and 9 may be enhanced next valid character trees, i.e. they may comprise one or more combined nodes (grapheme nodes).

The device 500 may comprise a user interface UIF1 for receiving commands from a user and/or for providing information to the user. An input name may be selected by using the user interface UIF1. The user interface UIF1 may comprise e.g. a touch screen for visually displaying information and for receiving commands from a user. The user interface UIF1 may comprise hardware, e.g. a display, keypad and/or a touch screen. The user interface may comprise a display screen for viewing graphical elements displayed on the screen. The user interface UIF1 may comprise a software application e.g. for displaying various different virtual keys on a touch screen. The user interface UIF1 may comprise one or more virtual keys for receiving instructions from the user. The virtual keys may be implemented on the touch screen. The user interface UIF1 may comprise one or more push buttons for receiving instructions from the user. The user interface UIF1 may comprise a keypad for receiving instructions from the user. The user interface UIF1 may comprise a touchpad, a keypad, a mouse and/or a joystick for receiving instructions from the user. In an embodiment, the user interface UIF1 may comprise a microphone and a speech recognition unit for receiving instructions, which are spoken aloud. The user interface UIF1 may be implemented e.g. in a portable device, e.g. in a smart phone. A user may receive information via the interface UIF1. The user may control operation of the device 500 by giving commands via the user interface UIF1. When using a touch screen, the user may input information by touching the touch screen with a touching member. The touching member may be e.g. a finger or a stylus. Touching the touch screen may refer to actual physical contact between the touching member and the screen. Touching the touch screen may also mean bringing the touching member close to the screen so that the distance between the finger H1 and the screen is smaller than a predetermined distance (e.g. smaller than 1% of the width of the touch screen).

For the person skilled in the art, it will be clear that modifications and variations of the devices and the methods according to the present invention are perceivable.

The figures are schematic. The particular embodiments described above with reference to the accompanying drawings are illustrative only and not meant to limit the scope of the invention, which is defined by the appended claims.

1-84. (canceled)

85. A method, comprising:
providing a first name, the first name comprising a first character represented by a first character code,
providing a second name, the second name comprising a second character represented by a second character code, wherein the first character and the second character are homoglyphs with respect to each other, and
generating a next valid character tree according to the names such that the next valid character tree comprises a combined node, which is a place holder for the first character and for the second character.

86. The method of claim 85, comprising forming one or more child nodes to the next valid character tree according to the second name.

87. The method of claim 85, comprising dividing a node of the next valid character tree into an ancestor node and a child node according to the first name and according to the second name.

88. The method according to claim 85, wherein the first character belongs to a first alphabet, the second character belongs to a second alphabet, and the first alphabet and the second alphabet are selected from a group consisting of Latin alphabet, Cyrillic alphabet, and Greek alphabet.

89. The method according to claim 85, comprising:
providing a variant name by replacing a first substring of the first name with a second different substring such that the first substring and the second substring represent the same phoneme, and
updating the next valid character tree according to the variant name such that the next valid character tree comprise nodes for selecting the first name and nodes for selecting the variant name.

90. The method according to claim 85, comprising selecting an input name by:
selecting a character for a first position from a list of characters determined by the next valid character tree, and
selecting a character for a second position from a list of characters determined by the next valid character tree and by the character selected for the first position,
wherein said combined node is a place holder for the character selected for the first position or for the second position.

91. The method according to claim 85, comprising obtaining the database and/or the next valid character tree to a mobile device via the Internet.

92. The method according to claim 85, comprising defining the input name by a touch screen.

93. The method according to claim 85, comprising:
selecting a first candidate name which is substantially similar to a second candidate name but not identical to the second candidate name, and
displaying at least a part of the second candidate name in addition to displaying at least a part of the first candidate name.

94. The method according to claim 93, wherein the first candidate name is associated with a first indicator value, and the second candidate name is associated with a second indicator value, wherein the method comprises:
displaying at least a part of the first candidate name and at least a part of the second candidate name in an order, which is determined by the first indicator value and by the second indicator value.

95. An apparatus comprising one or more processors configured generate a next valid character tree according to a first name and according to a second name such that the next valid character tree comprises nodes for selecting the first name and nodes for selecting the second name, wherein the first name comprises a first character represented by a first character code, the second name comprises a second character represented by a second character code, the next valid character tree comprises a combined node, which is a place holder for a first character and for a second character, and the first character and the second character are homoglyphs with respect to each other.

96. The apparatus of claim 95, wherein one or more processors of the apparatus are configured to add one or more child nodes to the next valid character tree according to the second name.

97. The apparatus of claim 95, wherein one or more processors of the apparatus are configured to divide a node of the next valid character tree into an ancestor node and a child node according to the first name and according to the second name.

98. The apparatus according to claim 95, wherein the first character belongs to a first alphabet, the second character belongs to a second alphabet, and the first alphabet and the second alphabet are selected from a group consisting of Latin alphabet, Cyrillic alphabet, and Greek alphabet.

99. The apparatus according to claim 95, wherein one or more processors of the apparatus are configured to:
provide a variant name by replacing a first substring of the first name with a second different substring such that the first substring and the second substring represent the same phoneme, and
update the next valid character tree according to the variant name.

100. The apparatus according to claim 95, comprising a user interface for defining an input name by selecting one of the names, wherein one or more processors are configured to:
provide a first list of valid characters for selecting a character for a first position,
provide a second list of valid characters for selecting a character for a second position, wherein that the first list and/or the second list is provided by using said combined node.

101. The apparatus according to claim 95, wherein the apparatus is configured to obtain a database and/or a next valid character tree via the Internet.

102. The apparatus according to claim 95, comprising a touch screen for defining an input name.

103. The apparatus according to claim 95, wherein the apparatus is configured to display at least a part of a first candidate name and at least a part of a second candidate name when a first candidate name is selected, wherein the second candidate name is substantially similar to the first candidate name but not identical to the first candidate name.

104. The apparatus of claim 103, wherein the first candidate name is associated with a first indicator value, and the second candidate name is associated with a second indicator value, and the apparatus is configured to display at least a part of the first candidate name and at least a part of the second candidate name in an order, which is determined by the first indicator value and by the second indicator value.
